(19) United States
(12) Patent Application Publication
(10) Pub. No.: US 2005/0238220 A1
(43) Pub. Date: Oct. 27, 2005

(54) Method and device for inspecting linear infrastructures

(76) Inventors: Angel Maria Guerra Llamas, Madrid (ES); Manuel Domingo Fernandez Pellicer, Madrid (ES); Domingo Fernandez Alvarez, Madrid (ES); Alfonso Delgado Sancho, Madrid (ES); Maria Jose Saenz De Buruaga Molina, Madrid (ES); Tomas Nistal Rodriguez, Madrid (ES)

Correspondence Address: KNOBBE MARTENS OLSON & BEAR LLP, 2040 MAIN STREET, FOURTEENTH FLOOR, IRVINE, CA, 92614, US

(21) Appl. No.: 11/048,299

(22) Filed: Jan. 31, 2005

Related U.S. Application Data
(63) Continuation of application No. PCT/ES02/00389, filed on Aug. 1, 2002.

(51) Int. Cl. G06K 9/00

(52) U.S. Cl. 382/141

(57) ABSTRACT

A method and the respective devices for the automatic or manual inspection of linear infrastructures, such as electric lines, which is controlled by a single operator are disclosed. The system is divided into two stages: an on-board stage on a mobile and a subsequent post-processing stage in which the final report is issued. The on-board equipment comprises two gyrostabilized platforms, one of which is responsible for collecting panoramic images that will provide general information on the lines, and the other is configured to automatically capture detailed images.

### CROSS REFERENCE TO RELATED APPLICATION

This application claims priority under 35 U.S.C. § 120 to PCT International Application Number PCT/ES02/00389, filed on Aug. 1, 2002 and published in a language other than English. The disclosure of the above-described filed application is hereby incorporated by reference in its entirety.

### DESCRIPTION

1. Field of the Invention

The present invention refers to a method and a device, installed in a mobile means, for inspecting linear infrastructures, such as railway lines, overhead electric lines, gas pipelines, etc.

2. Background of the Invention

Correct maintenance of certain linear infrastructures, such as overhead electric lines, as well as management of stock taking, has taken on special importance due to the needs generated at the electricity companies for optimizing facilities, reducing operating costs, increasing reliability and improving the service and customer confidence.

Traditionally, overhead medium and high voltage lines have been inspected from the ground by teams or gangs walking the whole length of the lines, backed up by off-road vehicles.

These inspections, which are performed at intervals depending on the type of line, the company's policy or if legally stipulated even, generally speaking require a double inspection. One, consisting of a quick run over, in order to detect major faults that may arise in the actual line and survey the surroundings, and the other more detailed, which is carried out sometimes by climbing the line supports in order to detect possible defects in its components.

Airborne inspection devices have been used for years, mostly installed in helicopters, fitted with gyrostabilized platforms with infrared spectrum sensors for thermographic inspection and visible spectrum sensors for visual inspection.

On high voltage lines both the foregoing types of inspection mentioned are performed, one more general and for surveillance of the surroundings, and the other equivalent to what would be done by an inspector who climbed up the support to examine the line components for defects, which entails the need to perform two types of inspections at a different rate: while the general inspection may be performed at 40-60 km/h, the detailed one is done at 7-20 km/h, depending on the line voltage.

Medium voltage lines, below 45 kv., all present added problems which make it not viable to use conventional airborne systems for inspecting them. To be specific, these lines are more irregular and therefore more difficult to follow from a helicopter, besides the fact that the number of branches present gives rise to a larger number of non-operational flights, thus reducing inspection efficiency enormously, which has an impact on cost and makes the application of these systems uneconomic.

Airborne systems for inspecting overhead electric lines are known, such as those disclosed by the Japanese patents with publication number JP-03060311, JP-03060312 and JP-03060313, which consist of a system for capturing images of overhead electric lines which focus on the capture of images through a TV camera, so as to reproduce these images later upon returning to base and convert them into digital images, which are stored and subsequently processed. The processing of these images is geared to detecting sharp variations in brightness, which may indicate trouble in said line.

Similar comments may be made on Japanese patents with publication numbers JP-10117415 and JP-04156212, which are based on the processing and subsequent digitalization of the images captured by a TV camera operated from a helicopter, for processing on the ground, where troubles in such lines may be detected by means of certain parameters, such as brightness and sudden changes in it.

All these inventions, however, are based on the processing of the images captured, but none of them is aimed at a prime defect of these systems, which is their slowness and lack of stability in the process of capturing images of the line.

### SUMMARY OF CERTAIN INVENTIVE EMBODIMENTS

The method and device for inspecting linear infrastructures advocated here resolves the afore-mentioned problem to full satisfaction, with the result that a single operator controlling all the systems may carry out a single inspection of the linear infrastructure at a lower financial cost.

The purpose of the invention consists of the visual and thermographic and visual control of these linear infrastructures quickly and safely, which is carried out with great precision in a wholly independent manner, without the need for human intervention in the capture of the information on the basis of which this control is performed; with the result that the mobile means that captures this information can move at a speed that is higher than when supervision is carried out by hand.

For this purpose and more specifically the invention proposed refers to a method for inspecting linear infrastructures, such as for instance overhead electric lines, either automatically or semi-automatically, by means of on-board devices on an aerial or land mobile means independent of the latter, which are handled by a single operator who controls all the systems.

The inspection method is arranged in two stages. First of all, collection of information, which is carried out by means of the on-board device on the mobile means, for instance, a helicopter, and which is provided, amongst other things, with two gyrostabilized platforms that operate in an independent and simultaneous way, one of which will be responsible for collecting the panoramic images and the other responsible for collecting the detailed images, the second stage of the method being of the subsequent post-processing which is carried out in the laboratory.

The method consists, in short, of the capture of information carried out from the mobile, which may be aerial or land, of the lie of the electric line or linear infrastructure in question, on the basis of the knowledge by the system of the spatial positions of the facilities to be checked during the inspection. At the information collection stage the following operations are performed:
Visual panoramic capture of the sequence of images of the lie and surroundings of the line in an automatic or semi-automatic way.
Detailed automatic capture of images of the line components with high spatial resolution.
Thermographic capture of the line components by way of an infrared spectrum camera with a radiometric high-sensitivity detector, with automatic capture of images in digital format
Capture of data relating to the position and attitude of the helicopter, attitude of the image capturing devices, sensor aiming lines, and other navigation data, with a common time base.
   In the post-processing stage the following tasks are performed:
Synchronous reproduction of the mission with editing of stored data sources, for carrying out the inspection on them and evaluation of the state of the facility.
Positioning of supports or components of the line or its surroundings which make it possible to calculate the exact situation of any of these points with a precision of less than 3 metres.
Measurement of relative distances between conflictive points on the basis of line images captured, such as the distance between the conductor and the ground, other lines, nearby buildings, roads, etc.
Automatic hotspot detection from the infrared spectrum images.

The on-board gyrostabilized platforms will operate in a self-contained, simultaneous and independent fashion, thereby achieving a panoramic and detailed inspection without the need for the helicopter to stop when reaching the supports.

Detailed images of sufficient spatial resolution are captured thanks on the one hand to the fact that the sensor responsible for capturing these images has a large number of sensitive elements (pixels), and, on the other, because the field of vision is narrower. The resultant spatial resolution in the images is higher and enables a greater level of detail to be made out than in the panoramic images during post-processing in the laboratory.

The first platform panoramic sensors carry out a sweep over the line, directed either automatically by the automatic aiming device, or else manually by means of the action of the operator on the control console of this platform. In the former case the automatic aiming is done in accordance with the pre-defined position of the line, the position of the helicopter obtained by means of a satellite global positioning system global, such as GPS and inertial systems that determine the attitude of the helicopter. If the operation is done manually, due to the absence of data on the position of the infrastructure to be analyzed, the actual operator will be the one to guide this first platform.

The second platform detail sensors aim automatically at one of the objects predetermined before the mission. In automatic operating mode the aiming line is defined from the predefined position of all the objects, and the position and attitude of the helicopter measured. In the event of the first platform being guided manually, the second platform uses the data collected by the first one, which obtains panoramic images, so as to aim automatically at different elements of the linear infrastructure.

The on-board means or devices make it possible to use the data stored and acquired in real time to calculate and control the lines of sight of each of the image capturing systems forming the device, while these lines of sight and fields of vision of the image acquisition devices are independent of one another and parameterizable in accordance with the type of linear infrastructure to be inspected.

In this aerial inspection, the operator is aided by a navigation or geographic information system which indicates the helicopter's position and the course followed, the lie of the lines on which the inspection is being carried out and the mapping of the surrounding area. The aiming lines and fields of vision of the different sensors are also shown to facilitate the inspection operation.

All the on-board systems are independent of the helicopter's own avionics: inertial systems, GPS, altimeters, audio intercommunicators, etc., so the system is completely portable and adaptable to different helicopters or mobile means assigned to inspection.

These on-board systems are also managed by a single operator, who controls the whole of the systems with a single interface. The central unit on-board the mobile means stores or records all the information obtained in conjoint fashion: GPS flight positions, positions of the support bases, panoramic visual images, detail visual, infrared spectrum images, helicopter attitude, flying time, etc., so that in the subsequent processing in the laboratory the whole inspection may be reproduced in synchronized form, with the result that direct access may be obtained to any of the data sources from a single input.

All these system capabilities, and whenever there is information on the geographic position of the facility, make it possible for the device to be able to aim the sensors automatically towards said facility so that the manual intervention will not be required of the operator, who will only have to make the necessary checks on the proper working of all the system equipment.

To perform any inspection operation and in the specific of it being a medium voltage line, the mobile means may be aerial and, more specifically, a helicopter, which will fly over this line at a constant speed of 80-100 km/h, at a vertical distance above the ground of some 50-65 metros, with a lateral displacement over the axis of the line of 0-15 metros. In the case of a high voltage line, the speed is reduced to 35-60 km/h.

When the aerial inspection has been performed, the whole of the information is transferred to the laboratory, where all the information collected in the field is analyzed and in the end the report is issued with the diagnosis and appraisal made. Finally, a management system is designed that adapts to every customer's needs, so that the information supplied to maintenance supervisors will be a suitable basis for scheduling correct effective maintenance.

Since the position obtained from the GPS do not match up with the coordinates of the objects visualized in the images, but with the position of the helicopter, triangulation algorithms have been developed for calculating the global 3D position of an object from the two images where it appears, which are used both for sighting the defects detected and for correcting data relating to the position of the facility that might be incorrectly loaded in the starting database.

For this post-processing laboratory stage and in order to reduce the work of analyzing the information captured while flying over the line and to minimize possible human errors, the following algorithms have been developed:
Measurement of relative 3D distances between two points,
Positioning by means of absolute coordinates
Improvement and enhancement of visible and infrared spectrum images,
Automatic hotspot detection by means of a morphological erosion process

All this information processed during a first inspection at a specific facility may be used in subsequent inspections, feeding the system back and thereby improving its performance.

### BRIEF DESCRIPTION OF THE DRAWINGS

To complete the description that is being given and in order to assist a better understanding of the features of the invention, in accordance with a preferred embodiment of same, a set of drawings is attached as an integral part of this description wherein, for purely informative and non-restrictive purposes, the following is represented:

FIG. 1 is a block diagram of the on-board devices with which the first stage or phase of the inspection method is performed.

FIG. 2 is a block diagram of the devices used in the post-processing laboratory with which the second stage or phase of the inspection method is performed.

### DETAILED DESCRIPTION OF CERTAIN INVENTIVE EMBODIMENTS

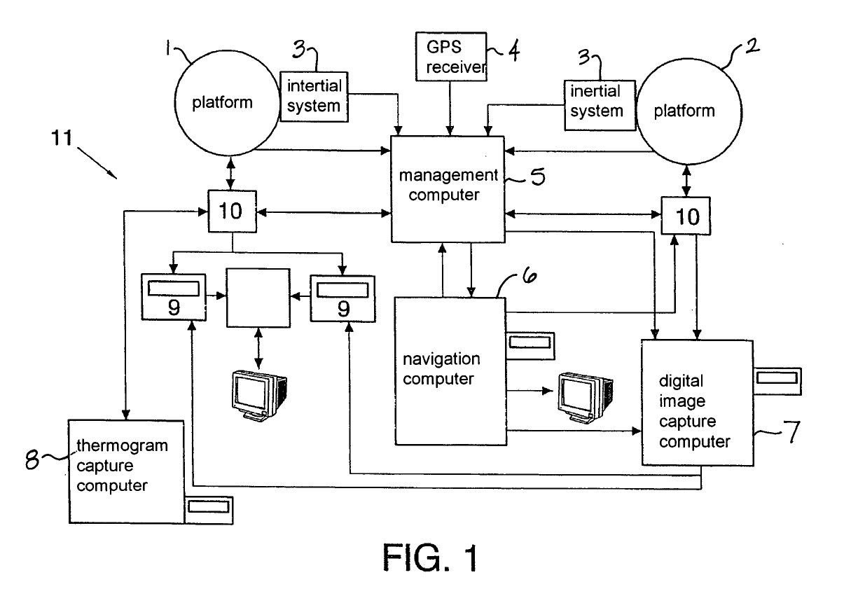

In the above-mentioned figures, specifically in FIG. 1, a block diagram is represented of the on-board devices with which the first stage or phase of the inspection method is performed.

The on-board system (11) is made up of two gyrostabilized platforms. The panoramic platform (1), which may be controlled automatically or manually, is responsible for capturing images in video format, with a broad fixed field of vision, so as to be able to make the diagnosis of the line environment: tree-covering, crossings, etc. and which also has a radiometric high-resolution infrared sensor that supplies infrared images in PAL format and thermograms which are stored in digital format for subsequent analysis.

The other platform (2), which obtains the detailed information, is made up of a digital video system that captures high resolution digital photographs. The subsequent processing of these photographs will offer detailed information on the state of the facilities (staples, cables, insulators, protection devices, etc.).

Both platforms (1) and (2) are oriented (10), the first manually or automatically, and the second automatically, in such a way that simultaneous images are captured with two different fields of vision and resolution.

The on-board devices (11) also include an AHRS inertial system (3) for measuring the attitude of the helicopter all the time, a GPS receiver (4) with differential correction in real time which supplies the helicopter's position in real time; a management computer (5) which contains a module that enables changes to be made in respect of the mission previously generated in the laboratory; another one that gives the required navigation and aiming data for the mission to be carried out and which stores the data while the mission is being performed; another one which controls the digital camera, and another which controls the infrared camera; a navigation computer (6) which contains a module that calculates the line of sight of the platforms all the time for the mission to be performed automatically and a module that indicates the state of all the equipment making up the on-board system and gives an alarm signal if a failure occurs in any of these items of equipment; a computer for capturing digital images (7) which stores the digital photographs that are taken with the detail platform (2) in real time and without compression; a computer for capturing thermograms (8) which carries out the capture of thermograms in digital format for subsequent analysis in the laboratory; and lastly, DV-CAM format recording videos (9).

Devices (4, 5, 6, 7, 8 and 9) are built into an industrial rack which houses all these devices, provided with a single keypad that gives access to the different computers or CPUs and allows images from any of the sources to be viewed, while also collecting with the same time base all the data and images needed for the subsequent processing of the information in the laboratory.

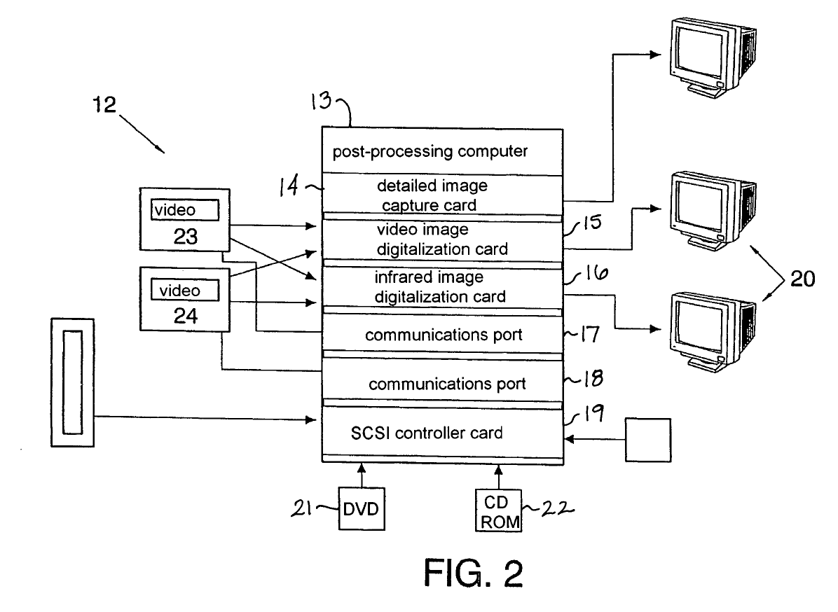

The devices forming part of the post-processing stage (12) are shown in FIG. 2, containing a diagrammatic representation of these devices, which act together with the specific algorithms developed to automate and optimize the tasks performed during analysis in the laboratory and which basically consist of a post-processing PC (13) that comprises a whole series of devices for the processing of the images, such as a detailed image capturing card (14), a video image digitalization card (15), an infrared image digitalization card (16), two communications ports (17 and 18), SCSI controller card (19), as well as the respective display monitors (20), DVD (21), CD-ROM (22) and video units (23, 24).

If the starting data are not too precise, the efficiency of the first inspection that is performed on a facility may fall short of the objective defined. In this case the data obtained from the first inspection would be fed back into the system, so that the efficiency of the inspection is increased at later inspections.

1. A device for inspecting linear infrastructures, comprising:
a system installed in a mobile for the automatic acquisition and capture of images and data; and
a post-processing device, not on-board the mobile, configured to process information and/or signals obtained by the on-board system, wherein the acquisition and capture of images and data by the on-board system is carried out irrespective of the movement of the mobile, and with various angles and lines of sights at the same time, aiming the system at the linear infrastructure in an automatic or semi-automatic way on the basis of knowledge by the system of the spatial positions of a facility to be inspected.

2. The device for inspecting linear infrastructures according to claim 1, wherein the on-board system comprises two gyrostabilized platforms operating independently at the same time and irrespective of the movement of the mobile, wherein the platforms comprise image acquisition and capture systems.

3. The device for inspecting linear infrastructures according to claim 2, wherein a first of the gyrostabilized platforms is directed or aimed either automatically or manually, comprises an image acquisition and capture system configured for acquisition and capture of images in video format of the line environment, and an infrared sensor configured to generate infrared images and thermograms.

4. The device for inspecting linear infrastructures according to claim 2, wherein a second of the gyrostabilized platforms is directed or aimed automatically and comprises a digital video system configured to capture high resolution digital photographs.

5. The device for inspecting linear infrastructures according to claim 1, wherein the system for acquisition and capture of images is configured to simultaneously provide images in video format of the infrastructure in its surroundings, infrared images and thermograms, and high resolution digital photographs with detailed information on the state of the facilities of the linear infrastructure.

6. The device for inspecting linear infrastructures according to claim 1, further comprising a device configured to use the data stored and acquired in real time by the system to calculate and control the lines of sight of the systems for data and/or image capture.

7. The device for inspecting linear infrastructures according to claim 6, wherein the system for the automatic acquisition and capture of images and data comprises two or more image and data acquisition devices, and wherein the lines of sight and fields of vision of the image and data acquisition devices are independent of one another and parameterizable features of the infrastructure to be inspected.

8. The device for inspecting linear infrastructures according to claim 1, wherein the on-board system comprises a device configured for the acquisition of data of the attitude of the mobile and the geographical position mobile in real time.

9. The device for inspecting linear infrastructures according to claim 1, wherein the on-board system comprises a device for recording and storing the information acquired and captured with a common time base so that in the subsequent processing the whole inspection may be reproduced in synchronized form, with the result that direct access may be obtained to any of the data sources from a single input.

10. The device for inspecting linear infrastructures according to claim 1, wherein the post-processing device comprises a device configured to calculate the geographic position of the defects detected in the inspection and the position of the infrastructure itself by triangulation algorithms developed for calculating the global 3D position of an object from two images taken from two different angles, and wherein the post-processing device further comprises a device configured to automatically detect hotspots from infrared spectrum images acquired by the on-board system.

11. The device for inspecting linear infrastructures according to claim 1, wherein the mobile is at least one of an aircraft and a land vehicle.

12. A method of inspecting linear infrastructures, comprising:
obtaining data relating to the spatial position of the linear infrastructure that is to be inspected;
capturing, using automatic panoramic visual capture, the linear infrastructure to be inspected in video format of the infrastructure and its surroundings;
capturing, using automatic detailed visual capture, the components of the linear infrastructure to be inspected, comprising obtaining digital images of the components of the linear infrastructure inspected;
capturing, using automatic capture in infrared spectrum, the components of the linear infrastructure inspected, and detecting, post-process in the obtained images, possible hotspots in the linear infrastructure inspected;
recording, by an on-board system installed on a mobile and comprising one or more sensors, filming cameras, navigation and control sensors, and audio sensors, data obtained by the one or more sensors, filming cameras, navigation and control sensors, and audio sensors, with a common time base;
analyzing, using a post-process device not installed on the mobile, the data and images obtained by the on-board system during the inspection of the linear infrastructure;
storing the data processed by the post-processing device; and
generating reports on the state, situation, and defects found in the linear infrastructure analyzed.

13. The method for inspecting linear infrastructures according to claim 12, further comprising obtaining and processing, by the post-processing device, linear infrastructure positioning data, wherein the linear infrastructure positioning data has the precision sufficient to feed the system on successive linear infrastructure inspections.

14. A method of inspecting linear infrastructures, comprising:
capturing in video format, using panoramic visual capture, the linear infrastructure to be inspected and its surroundings, wherein capturing in video format comprises manual operation with operator intervention;
capturing, using automatic detailed visual capture, the components of the linear infrastructure to be inspected by obtaining digital images of the components of the linear infrastructure to be inspected;
capturing, using automatic capture in infrared spectrum, the components of the linear infrastructure inspected, and detecting in the digital images, post-process, possible hotspots in the linear infrastructure inspected;
recording, by an on-board system installed on a mobile and comprising one or more sensors, filming cameras, navigation and control sensors, and audio sensors, data obtained by the sensors, filming cameras, navigation and control sensors, and audio sensors with a common time base;
analyzing, using a post-process device not installed on the mobile, the data and images obtained by the on-board system during the inspection of the linear infrastructure;
storing the data analyzed by the post-processing device;
generating reports on the state, situation, and defects found in the linear infrastructure analyzed.

15. The method for inspecting linear infrastructures according to claim 14, further comprising obtaining and processing, by the post-processing device, linear infrastructure positioning data, wherein the linear infrastructure positioning data has the precision sufficient to feed the system on successive linear infrastructure inspections.
